(19) United States
(12) Patent Application Publication
(10) Pub. No.: US 2023/0331045 A1
(43) Pub. Date: Oct. 19, 2023

(54) Wheel and Tyre Assembly, Method of Manufacture and Use Thereof

(71) Applicant: Starco DML Ltd, Crewe Cheshire (GB)

(72) Inventor: Michael Andrews, Crewe Cheshire (GB)

(21) Appl. No.: 18/022,582

(22) PCT Filed: Jul. 30, 2021
(86) PCT No.: PCT/GB2021/051974

§ 371 Date: Feb. 22, 2023

(30) Foreign Application Priority Data
Jul. 30, 2020 (GB) 2011907.9

(51) Int. Cl. B60C 7/10

(52) U.S. Cl. CPC B60C 7/10; B60C 2007/005

(57) ABSTRACT

A wheel assembly and method of forming the same that incorporates a non-pneumatic tyre. The assembly includes a core means forming at least part of a wheel hub and leg members depending from the same, wherein at least part of the leg members are coated and/or over-moulded with at least one polymeric material.

The present invention relates to a new wheel assembly that includes a tyre which is particularly applicable to wheels including airless or non-pneumatic tyres.

Although the following description refers to a wheel assembly incorporating polyurethane tyres the skilled person will appreciate that other airless or non-pneumatic tyre materials could be used, for example other polymers such as rubber, polyethylene, nylon and the like.

The use of airless or non-pneumatic tyres on heavy vehicles such as fork lift trucks is known. Typically a solid polyurethane tyre is fitted to a metal rim which is connected to the vehicle axle. Solid airless tyres have the advantage of being able to carry a higher load without significant deformation as would be the case with a similar sized pneumatic tyre.

Airless tyres have a high rolling resistance and have issues with the heat build-up that occurs in use due to frictional forces. This heat causes the tyre to expand and can disrupt the close fit required to the rim.

It is therefore an aim of the present invention to provide a wheel and tyre assembly that addresses the abovementioned problems.

It is a further aim of the present invention to provide a method manufacturing a wheel and tyre assembly that addresses the abovementioned problems.

In a first aspect of the invention there is provided a wheel and assembly or apparatus incorporating a non-pneumatic tyre, said assembly including;
a core means forming at least part of the wheel hub and leg members depending from the same, wherein at least part of said leg members are coated and/or over-moulded with at least one polymeric material.

Typically the core means includes a substantially planar plate or surface forming the hub of the wheel assembly. In use the core means is attached to the vehicle axle or to the axle via a wheel hub assembly.

In a preferred embodiment at least the leg members of the metal core means are over moulded with a polymer such as polyurethane, producing a puncture proof wheel and tyre assembly.

Further typically the core means is substantially located or formed on a first plane. The core means typically defines a location by which the wheel can be attached to the vehicle.

Further typically the leg members are substantially planar.

Typically the leg members depend or extend from the core means in at least one direction or angle away from the plane of the core means.

In one embodiment the leg members depend away from the core means such that at least part of said leg members are at right angles or perpendicular to the core means.

Preferably the polymeric material coating and/or over moulding the core means and/or leg members forms the body of the wheel and/or at least part of the tyre.

In a preferred embodiment the polymeric material is polyurethane or polyurethane based material.

In one embodiment the polymeric material can be applied in one or more layers.

In one embodiment the properties of the polymeric material layers can be different. Typically the density and/or rigidity of the polymeric material can be adjusted to provide layers of different properties.

In one embodiment the polymeric material can form one or more bands around the edge or towards the outer surface, or tread, of the tyre in contact with the ground in use.

In one embodiment the polymeric material is polyurethane and includes at least one ring or layer of less dense or foamed polyurethane.

In a preferred embodiment the core means comprises metallic material. Typically the core means is formed from metal. Further typically the core means and/or leg members are formed from steel or stainless steel.

Depending on the application the core means and/or leg members can be formed from other metals and alloys including aluminium, titanium and/or the like.

In one embodiment the core means and/or leg members are formed from a polymeric material. Typically polymeric material forming at least part of the core means and/or leg members is harder or less flexible than the polymeric material coating or over moulding the same.

In one embodiment the core means and/or leg members are formed from nylon.

In one embodiment at least part of the core means is coated with primer and/or adhesive that promotes bonding between the core means and the polymeric material coating the same.

For example CILBOND® 49SF is a solvent based bonding agent to bond polyurethane to metals including steel.

In one embodiment the core means is formed from a blank. Typically the blank is steel and the blank is cut from the same before forming at least the leg members into the desired shape.

In one embodiment substantially the entire core means is coated or over moulded with polymeric material, thereby protecting the wheel hub formed by the central portion of the core means.

Typically the core means includes one or more apertures or formations to attach the wheel and tyre assembly to a vehicle hub assembly or axle.

In one embodiment the core means is coated or over-moulded with polymeric material thereby forming a protective layer or hubcap.

In a second aspect of the invention there is provided a method of producing or manufacturing a wheel and tyre assembly, said wheel and tyre assembly including a core means forming at least part of the wheel hub and leg members depending from the same, wherein said method includes the step of coating and/or over-moulding at least part of said leg members with at least one polymeric material.

Typically the polymeric material provides the base or support, and/or forms the body of the tyre.

In one embodiment the core means is formed from a cut blank. Typically the leg members are bent from a planar blank such that at least part of the leg members do not lie in substantially the same plane as the core means.

In one embodiment the leg members are formed or bent such that at least part of the leg member surface is at right angles to the surface of the core means.

In one embodiment the core means includes a plurality of leg means extending from the edge or radius of the same. Typically adjacent or alternating leg members extend in substantially opposite directions to each other.

Preferably the leg members for supports for the coating or over-moulding polymer.

Typically the blank is painted, coated and/or primed with a surface treatment. Further typically the surface treatment improves the bonding or is an adhesive between the leg members and the polymeric material over the same.

Specific embodiments of the invention are now described with reference to the following figures wherein;

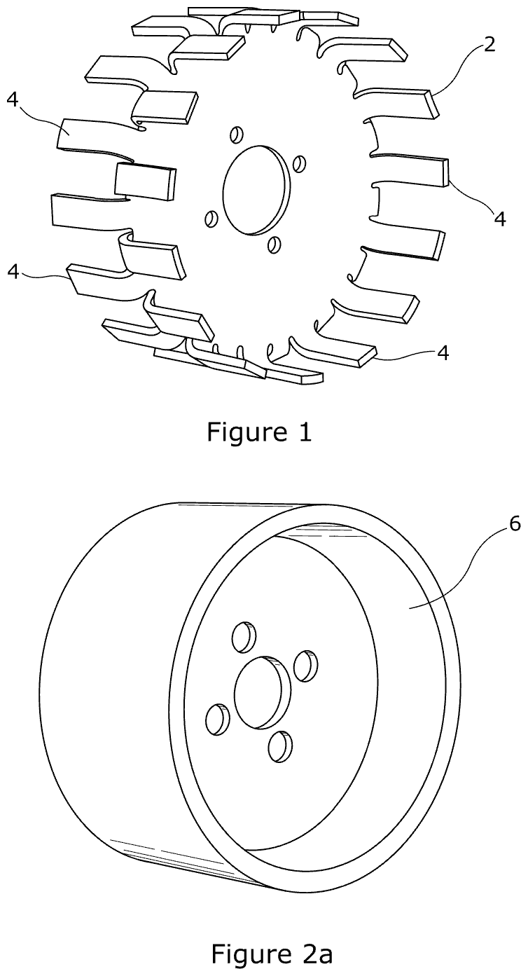

FIG. 1 shows core of the wheel and tyre assembly in accordance with one embodiment of the invention;

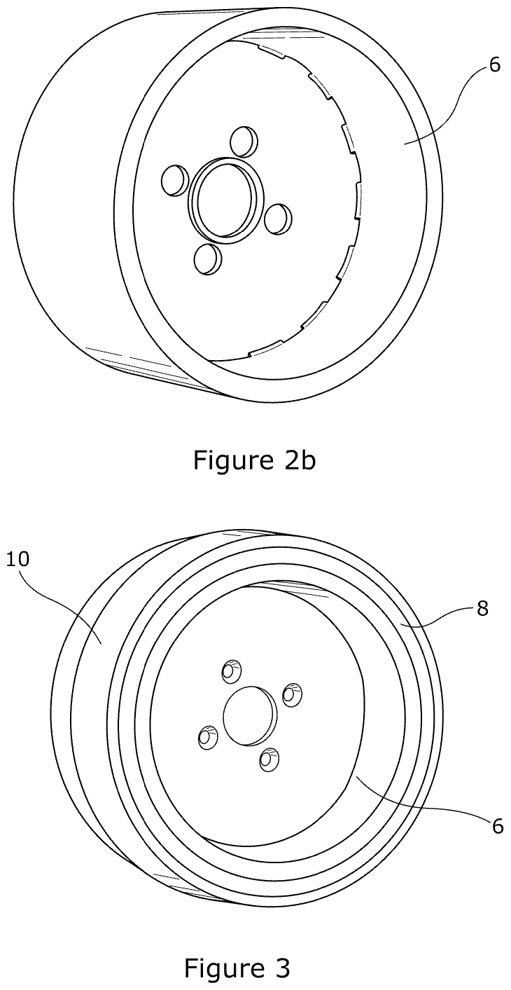

FIGS. 2a and 2b shows the wheel and tyre assembly with the polymeric coating applied in accordance with an embodiment of the invention; and

FIG. 3 shows an embodiment of a wheel and tyre assembly in accordance with one embodiment of the invention with a hard outer tread layer and a softer intermediate layer;

The present invention provides an apparatus and method for producing such an apparatus being a multi-purpose, puncture-proof wheel & tyre assembly.

The wheel can be made from many suitable materials relevant to the desired application. FIG. 1 shows steel blank or core 2 that is pre-cut and then formed to create support legs 4.

The blank or core 2 can be painted, e-coated or primed with suitable surface treatment for the given application. It is then over-moulded with a suitable polymer 6, as shown in FIG. 2, to create an interface for the steel blank and the tyre.

In this example the steel blank 2 is e-coated for corrosion resistance with a material that will bond to a polyurethane coating during the moulding cycle.

This polyurethane coating 6 will have suitable strength and stiffness to create the desired wheel rim. Bonding to the e-coat improves overall strength and durability. The steel blank can also be coated with the polyurethane to create a protective layer against stone impacts and the like and corrosion.

The steel blank is unique in its method of construction and is efficient in material use by minimising scrap and offcuts.

Importantly it removes the need for welding or bolting rim halves together which is current common practice.

The structural polyurethane layer 6 can be bonded further layers to form the wheel and tyre assembly, or can be moulded into a suitable shape to form a tread and even a shape to accept a pneumatic tyre if desired.

The use of polyurethane has an advantage in that polyurethane outer can be build-up as many layers as desired for the given application giving unlimited variation in load deflection performance. Layers can be made from various hardness's and densities as polyurethane can be moulded in a range of solid hardness's and a range of micro-cellular hardness's and densities.

In addition by using polyurethane we can also vary the base compounds to either provide rebound or shock absorption as required, or combine them for complex requirements.

During the moulding cycle and by using thermoset polyurethane, each layer can be chemically bonded together providing very reliable, repeatable and tough bonds. This removes the need for adhesives between the polymer layers as is required in other applications.

In the example given in FIG. 3, an intermediate foamed polyurethane layer 8 is incorporated which lies underneath a harder and denser outer polyurethane tread layer 10.

The skilled person will appreciate that using polymeric coatings, hub caps and other such items can be over-moulded and secured in-place as required.

Further, usually for heavy applications one or more cores 2 or centre discs can be combined to increase strength. This combination can also be used for aesthetics as required. If more than one core is used they can be pre-welded, screwed together and/or rely on the bond of the intermediate polyurethane layer, whichever is required for the application.

The skilled person will appreciate that the leg off-set shown in FIG. 1 can be achieved by cutting the blank and bending the legs in opposite directions, or by using two or more centre discs or cores and bending the legs in the same direction as required.

A further environmental advantage is that at the end of life the centre discs or cores 2 can be recovered and re-used by removing the remaining urethane: if burning is used, energy from this process can be salvaged or recovered. Polyurethane can also be removed mechanically and/or chemically.

If the centre discs are cut and formed from spring steel, the legs can be formed to create springs which can work in conjunction with layer or layers of polyurethane. These legs can also be used to transfer heat away from the centre of the polyurethane, to prevent it over-heating during high speed operation; which is a known problem. The size and shape of the formed steel “legs” can be optimised to remove as much heat as possible. This can be combined with features on the tyre and or wheel and or hub to encourage air-flow to the steel or other metal insert (which is known technology), to remove heat As shown in FIG. 2b.

1. A wheel assembly incorporating a non-pneumatic tyre, said assembly including;
a core means forming at least part of the wheel hub and leg members depending from the same, wherein at least part of said leg members are coated and/or over-moulded with at least one polymeric material.

2. The wheel assembly according to claim 1 wherein the core means includes a substantially planar plate or surface forming the hub of the wheel assembly to attach a vehicle axle to the wheel assembly.

3. (canceled)

4. (canceled)

5. The wheel assembly according to claim 1 wherein the leg members are over moulded with a polyurethane or polyurethane based polymer.

6. (canceled)

7. The wheel assembly according to claim 1 wherein the core means is substantially located or formed on a first plane, the leg members are substantially planar and depend or extend from the core means in at least one direction or angle away from the plane of the core means.

8. (canceled)

9. (canceled)

10. The wheel assembly according to claim 7 wherein the leg members depend away from the core means such that at least part of said leg members are at substantially right angles or perpendicular to the core means.

11. The wheel assembly according to claim 5 wherein the polymeric material coating and/or over moulding the core means and/or leg members forms the body of the wheel and/or at least part of the tyre.

12. The wheel assembly according to claim 11 wherein the polymeric material is applied in one or more layers.

13. The wheel assembly according to claim 12 wherein the density and/or rigidity properties of the polymeric material layers are different.

14. The wheel assembly according to claim 13 wherein the polymeric material can form one or more bands around the edge or towards the outer surface, or tread, of the tyre in contact with the ground in use.

15. The wheel assembly according to claim 14 wherein the polymeric material includes at least one ring or layer of less dense or foamed polyurethane.

16. The wheel assembly according to claim 2 wherein the core means and/or leg members are formed from steel, stainless steel or nylon.

17. (canceled)

18. (canceled)

19. (canceled)

20. (canceled)

21. The wheel assembly according to claim 16 wherein the entire core means is coated or over moulded with polymeric material, thereby protecting the wheel hub formed by the central portion of the core means.

22. (canceled)

23. A method of producing or manufacturing a wheel and tyre assembly, said wheel and tyre assembly including a core means forming at least part of the wheel hub and leg members depending from the same, wherein said method includes the step of coating and/or over-moulding at least part of said leg members with at least one polymeric material.

24. The method according to claim 23 wherein the polymeric material provides a base or support, and/or forms a body of the tyre.

25. The method according to claim 23 wherein the core means is formed from a cut blank.

26. The method according to claim 25 wherein the leg members are bent from a planar blank such that at least part of the leg members do not lie in substantially a same plane as the core means.

27. The method according to claim 25 wherein the leg members are formed or bent such that at least part of the leg member surface is at right angles to the surface of the core means.

28. The method according to claim 25 wherein the core means includes a plurality of leg means extending from the edge or radius of the same.

29. The method according to claim 28 wherein adjacent or alternating leg members extend in substantially opposite directions to each other.
